(19) United States
(12) Patent Application Publication
(10) Pub. No.: US 2016/0078981 A1
(43) Pub. Date: Mar. 17, 2016

(54) SIGNAL CABLE AND WIRE HARNESS

(71) Applicant: YAZAKI CORPORATION, Tokyo (JP)

(72) Inventor: Taketo Kumada, Shizuoka (JP)

(21) Appl. No.: 14/939,724

(22) Filed: Nov. 12, 2015

Related U.S. Application Data
(63) Continuation of application No. PCT/JP2014/062879, filed on May 14, 2014.

(30) Foreign Application Priority Data
May 15, 2013 (JP) 2013-102841

(51) Int. Cl. H01B 7/00; H01B 3/44; H01B 11/02; H01B 7/02; H01B 9/00

(52) U.S. Cl. CPC H01B 7/0045; H01B 7/02; H01B 9/003; H01B 11/02; H01B 3/441

(57) ABSTRACT

A signal cable is provided with a pair of power supply wires and a pair of signal wires. Each of the pair of the power supply wires is provided with a conductor and an insulator with which the conductor of the power supply wire is coated. Each of the pair of the signal wires comprises a conductor and an insulator with which the conductor of the signal wire is coated. The pair of the power supply wires and the pair of the signal wires are respectively disposed diagonally. The power supply wires and the signal wires are collectively twisted together, and the conductors of the power supply wires and the conductors of the signal wires are respectively twisted together in a state that strains of the conductors of the power supply wires and the conductors of the signal wires are within a range of an elastic region.

### CROSS REFERENCE TO RELATED APPLICATIONS

This application is a continuation of PCT application No. PCT/JP2014/062879, which was filed on May 14, 2014 based on Japanese Patent Application (No. 2013-102841) filed on May 15, 2013, the contents of which are incorporated herein by reference.

### TECHNICAL FIELD

The present invention relates to a signal cable and a wire harness including the signal cable.

### BACKGROUND ART

In the related art, a signal cable, which includes a pair of power supply wires disposed diagonally to each other and a pair of signal wires disposed diagonally to each other, and in which the power supply wires and the signal wires are collectively twisted together, has been disclosed (refer to PTL 1).

In this signal cable, the power supply wires and the signal wires are collectively twisted together. In this case, the number of twists is one, and thus it is possible to reduce an amount of time required to manufacture an electrical wire compared to when a twisted pair cable is prepared by twisting signal wires, a twisted pair cable is prepared by twisting power supply wires, and thereafter, these twisted pair cables are twisted together into one piece.

In addition, the signal wires are disposed diagonally to each other, and thus it is possible to increase the distance between the respective conductors of the signal wires, or to reduce the outer diameter of the cable having a predetermined value or higher of characteristic impedance. In such a signal cable, it is possible to reduce the occurrence of problems such as current being induced from the power supply wires to the signal wires, and devices being erroneously operated or responses of devices being delayed due to noise introduced into signals.

### PRIOR ART DOCUMENTS

### Patent Documents

[Patent Document 1] JPA Publication No. 11-39958

### SUMMARY OF INVENTION

### Problems that the Invention is to Solve

Meanwhile, in the manufacturing of the signal cable disclosed in PTL 1, it is necessary to perform an untwisting step during the processing of terminals, for example, a process of crimping terminals, and when it takes a large amount of time to untwist the wires, processing properties of the terminals may deteriorate.

The present invention is made to solve this problem, and an object of the present invention is to provide a signal cable and a wire harness through which it is possible to improve processing properties of terminals.

### Means for Solving the Problems

The signal cable of the present invention is characterized in that the signal cable is comprising a pair of power supply wires, and a pair of signal wires, wherein each of the pair of the power supply wires comprises a conductor, and an insulator with which the conductor of the power supply wire is coated, wherein each of the pair of the signal wires comprises a conductor, and an insulator with which the conductor of the signal wire is coated, wherein the pair of the power supply wires and the pair of the signal wires are respectively disposed diagonally, wherein the power supply wires and the signal wires are collectively twisted together, and wherein the conductors of the power supply wires and the conductors of the signal wires are respectively twisted together in a state that strains of the conductors of the power supply wires and the conductors of the signal wires are within a range of an elastic region.

In the signal cable of the present invention, conductors of power supply wires and conductors of signal wires are twisted together in a state that the strains of the conductors twisted together are within a range of an elastic region. For this reason, the conductors are not plastically deformed, and thus it is possible to relatively easily untwist the power supply wires and the signal wires in an untwisting step. As a result, it is possible to improve processing properties of terminals without spending a large amount of time in untwisting the wires.

The signal cable of the present invention, wherein the conductors of the power supply wires and the conductors of the signal wires are made of annealed copper, and wherein the conductors of the power supply wires and the conductors of the signal wires are twisted together in a state that the strains of the conductors of the power supply wires and the conductors of the signal wires are less than or equal to 0.5%.

In the signal cable, the conductors are made of annealed copper, and are twisted together in such a way that the strain of the conductors twisted together is less than or equal to 0.5%. For this reason, the twisting of the conductors of the power supply wires and the signal wires is performed in a range of the elastic region. As a result, even if the conductors are made of annealed copper, it is possible to improve processing properties of terminals without spending a large amount of time in untwisting the wires

The signal cable of the present invention, wherein the conductors of the power supply wires and the conductors of the signal wires are twisted together so that each of twist pitches is greater than or equal to 40 mm.

In the signal cable, the conductors of the power supply wires and the conductors of the signal wires are twisted together in such a way that the twist pitch is greater than or equal to 40 mm. For example, in the signal cable in which each of the power supply wires has a conductor outer diameter of 0.96 mm, each of the signal wires has a conductor outer diameter of 0.60 mm, and each of the insulator-coated power supply wire and the insulator-coated signal wire has an outer diameter of 1.4 mm, it is possible to limit the strain of the conductors twisted together to 0.5% or less by setting the twist pitch to be greater than or equal to 40 mm. Therefore, it is possible to limit the strain of the conductors to 0.5% or less by twisting the power supply wires and the signal wires together in order for the twist pitch to be greater than or equal to 40 mm while paying attention to the twist pitch according to the conductor outer diameter of each of the power supply wire and the signal wire, and the outer diameter of each of the insulator-coated power supply wire and the insulator-coated signal wire. As a result, it is possible to easily manufacture the cable.

The signal cable of the present invention, wherein the insulators of the power supply wires and the insulators of the signal wires are made of low density polyethylene or polyethylene foam.

In the signal cable, the insulator of the power supply wire and the insulator of the signal wire are made of low density polyethylene or polyethylene foam. The insulators are made of a material having a low hardness, and thus it is not necessary to spend a large amount of time in untwisting the wires. As a result, it is possible to further improve processing properties of terminals.

A wire harness of the present invention includes the aforementioned signal cable.

The signal cable can be used as one of a plurality of electrical wires of the wire harness. Since it is not necessary to spend a large amount of time in untwisting the signal cable, it is possible to reduce an amount of time required to manufacture the wire harness including the signal cable as one of the plurality of electrical wires.

### Advantageous Effects of Invention

According to the present invention, it is possible to provide the signal cable and the wire harness through which it is possible to improve processing properties of terminals.

### BRIEF DESCRIPTION OF DRAWINGS

FIG. 1 is a sectional view illustrating a signal cable in an embodiment of the present invention.

FIGS. 2A and 2B are perspective views illustrating signal cables, FIG. 2A illustrates a signal cable in a comparative example, and FIG. 2B illustrates the signal cable in the embodiment.

FIG. 3 is a graph illustrating a correlation between the strain and the stress of annealed copper.

FIG. 4 is a table illustrating an example of the signal cable in the embodiment.

FIG. 5 is a graph illustrating a correlation between a wire twist pitch and strain applied to a conductor (which is made of annealed copper).

FIG. 6 is a graph illustrating a correlation between a wire twist pitch and strain applied to a conductor (which is made of SnCC or an NN alloy).

### DESCRIPTION OF EMBODIMENTS

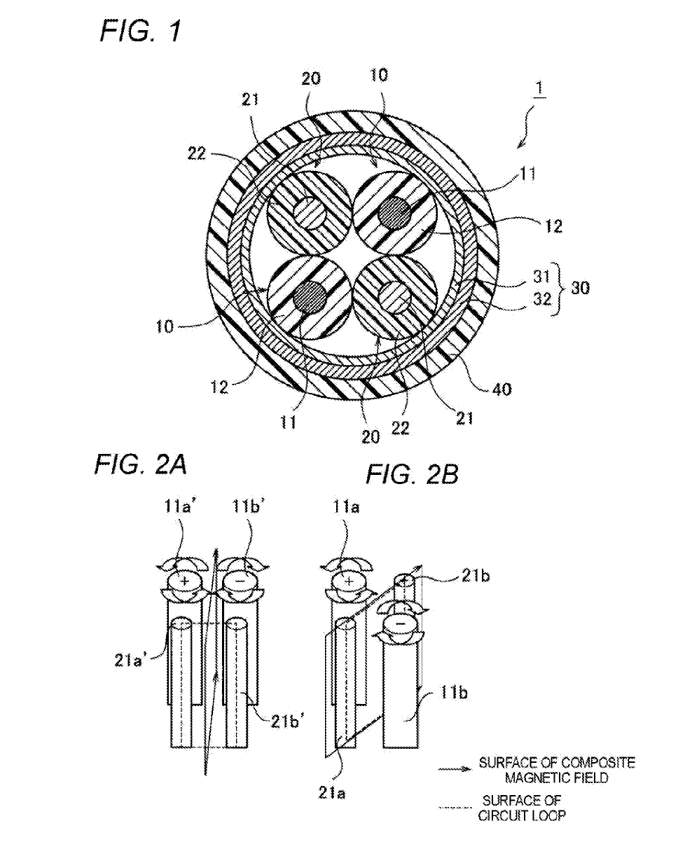

Hereinafter, a preferred embodiment of the present invention will be described with reference to the accompanying drawings. FIG. 1 is a sectional view illustrating a signal cable in an embodiment of the present invention. A signal cable 1 illustrated in FIG. 1 includes a pair of power supply wires 10; a pair of signal wires 20; a shielding layer 30; and a sheath 40.

The pair of power supply wires 10 is a pair of two electrical wires, of which each includes a conductor 11 and an insulator 12 with which the conductor 11 is coated, and through which electric power is supplied from a power source to devices which are connection destinations. The pair of signal wires 20 is a pair of two electrical wires, similar to the power supply wires 10, each including a conductor 21 and an insulator 22 with which the conductor is coated. The signal wires 20 serve to transmit control signals to devices therethrough such that the devices, which are connection destinations, are controlled.

Each of the conductors 11 of the power supply wires 10 and the conductors 21 of the signal wires 20 is made of annealed copper wires; however, the material of the conductors 11 and 21 is not limited to a annealed copper wire, and may be an alloy wire, a copper-coated steel wire, a silver-plated annealed copper wire, a tin-plated annealed copper wire, a tin-plated copper alloy wire, a tin plated copper-coated steel wire, or the like. Each of the insulators 12 and 22 is made of polyethylene (PE), polypropylene (PP), PE foam, or PP foam, and permittivity preferably is 3.0 or less.

In the embodiment, the power supply wires 10 and the signal wires 20 are collectively twisted together. That is, a twisted pair cable is prepared by twisting all of the four wires 10 and 20 together at once, and thus multiple twisting of the wires is not required, and a twisting step is simplified.

As illustrated in FIG. 1, the power supply wires 10 are disposed diagonally to each other, and the signal wires 20 are disposed diagonally to each other. In particular, since the signal wires 20 are disposed diagonally to each other, it is possible to increase the distance between the conductors 21. As a result, it is possible to reduce the outer diameter of the cable having a characteristic impedance of 90Ω or greater. When the finished outer diameter of the power supply wire 10 is different from that of the signal wire 20, the distance between the respective conductors 21 of the signal wires 20 is not stable, and thus a characteristic impedance is also not stable. For this reason, desirably, the power supply wire 10 and the signal wire 20 have the same finished outer diameter.

Since the power supply wires 10 are disposed diagonally to each other, and the signal wires 20 are disposed diagonally to each other, it is possible to provide the signal cable 1 which is very tolerant of noise. FIGS. 2A and 2B are perspective views illustrating signal cables, FIG. 2A illustrates a signal cable in a comparative example, and FIG. 2B illustrates the signal cable 1 in the embodiment. For the purpose of simplifying a description, FIGS. 2A and 2B illustrate the signal cables in which the wires are not yet twisted.

As illustrated in FIG. 2A, in the signal cable in the comparative example, power supply wires are adjacent to each other, and signal wires are also adjacent to each other. Current is supplied to devices, which are connection destinations, through the power supply wires, a conductor 11a′ of one of the power supply wires is positive, and a conductor 11b′ of the other of the power supply wires is negative. Accordingly, a magnetic field is formed around each of the conductors 11a′ and 11b′, and as illustrated in FIG. 2A, the surface of a composite magnetic field (illustrated by the solid lines in FIGS. 2A and 2B) passes through a middle position between both the conductors 11a′ and 11b′. Therefore, the surface of a circuit loop (illustrated by dotted lines in FIGS. 2A and 2B) formed by the respective conductors 21a′ and 21b′ of the signal wires is perpendicular to the surface of the composite magnetic field. As a result, induced current occurring in the power supply wires is easily induced to the signal wires.

In contrast, as illustrated in FIG. 2B, in the signal cable 1 in the embodiment, the power supply wires 10 are disposed diagonally to each other, and the signal wires 20 are disposed diagonally to each other. Therefore, as illustrated in FIG. 2B, the surface of a composite magnetic field passing through a middle position between both of conductors 11a and 11b is parallel to the surface of a circuit loop formed by the respective conductors 21a and 21b of the signal wires. As a result, induced current is almost not induced to the signal wires 20 through the composite magnetic field. The signal cable 1 in the embodiment has a structure which is very tolerant of noise.

With reference again to FIG. 1, as illustrated in FIG. 1, the shielding layer 30 is a member provided on an outer circumference of the power supply wires 10 and the signal wires 20. As the shielding layer 30, a braided member in which annealed copper wires, alloy wires, copper-coated steel wires, silver-plated steel wires, tin-plated annealed copper wires, or the like are braided together, aluminum foil, or the like is used. The shielding layer 30 has a two-layer structure such that the shielding layer 30 includes an inner shielding layer 31 and an outer shielding layer 32.

The sheath 40 is a member provided on an outer circumference of the shielding layer 30, and is made of PE, PP, polyvinylchloride (PVC), or the like.

In the manufacturing of the signal cable, it is necessary to perform an untwisting step during the processing of terminals, for example, a process of crimping terminals. When it takes a large amount of time to untwist the wires, processing properties of the terminals may deteriorate.

In the signal cable 1 according to the embodiment, the conductors 11 of the power supply wires 10 and the conductors 21 of the signal wires 20 are twisted together in such a way that stress of the conductors 11 and 21 twisted together is present within the range of an elastic range.

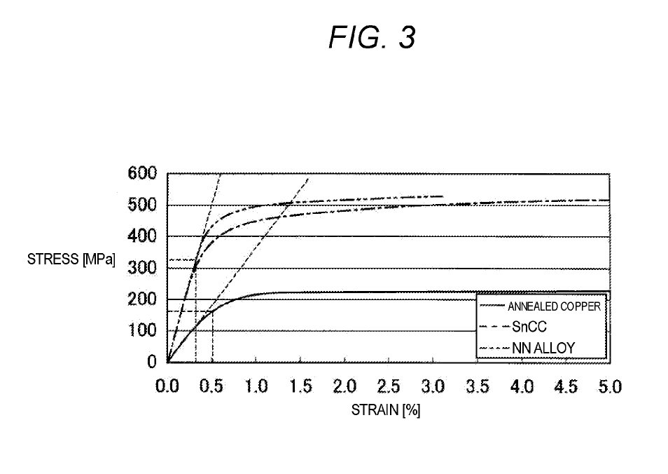

FIG. 3 is a graph illustrating a correlation between the strain and the stress of annealed copper. As illustrated in FIG. 3, it is understood that the stress of metal is linearly increased within an elastic region according to an increase in strain. For example, the elastic region of annealed copper is 0.5% stress or less, and the elastic region of a tin-chromium-copper alloy (SnCC) and a copper-tin alloy (NN alloy) is 0.3% or less.

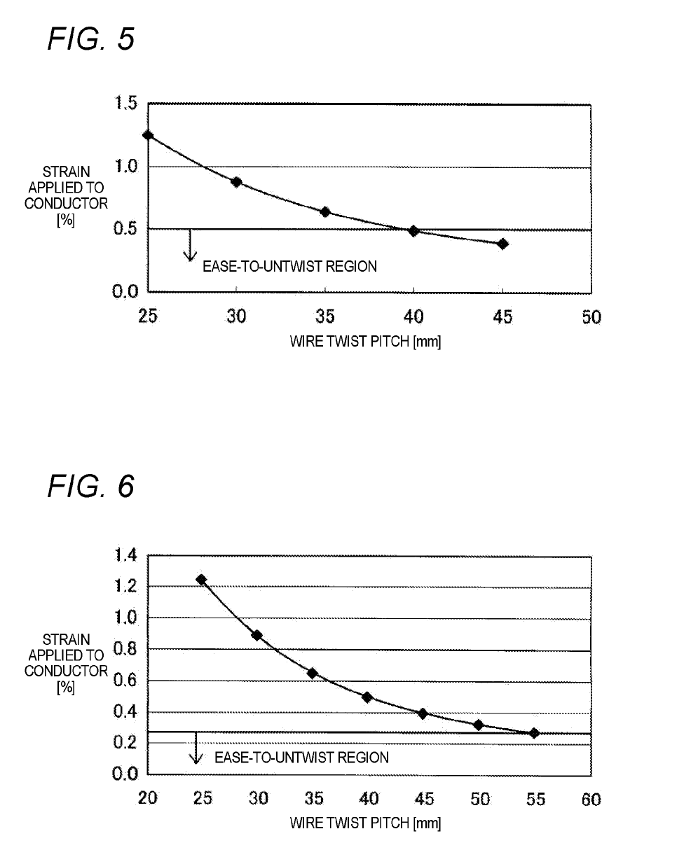

In the signal cable 1 according to the embodiment, the conductors 11 and 21 are twisted together in such a way that the strain of the conductors 11 and 21 twisted together is present within a range of the elastic region (when the conductors 11 and 21 are made of annealed copper, strain is less than or equal to 0.5%, and when the conductors 11 and 21 are made of SnCC or an NN alloy, strain is less than or equal to 0.3%). For this reason, the conductors 11 and 21 are not plastically deformed, and thus it is possible to relatively easily untwist the power supply wires 10 and the signal wires 20 in the untwisting step (refer to ease-to-untwist regions in FIGS. 5 and 6 which will be described later).

When the insulators 12 of the power supply wires 10 and the insulators 22 of the signal wires 20 are made of low density polyethylene (LDPE) or PE foam having a low hardness, or the like, it is possible to more relatively easily untwist the power supply wires 10 and the signal wires 20 in the untwisting step.

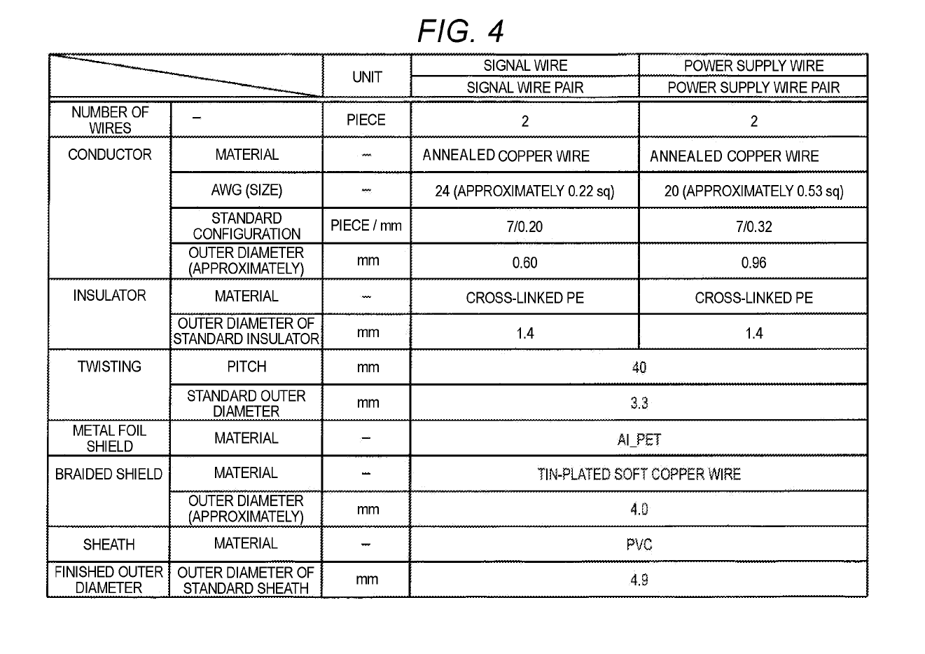

Hereinafter, an example of a method of manufacturing the signal cable 1 in the embodiment will be described. FIG. 4 is a table illustrating an example of the signal cable 1 in the embodiment.

In the embodiment, first, the power supply wire 10 and the signal wire 20 are manufactured so as to manufacture the signal cable 1. Specifically, seven AWG annealed copper wires (each wire having approximately 0.22 sq) are twisted together such that the conductor 21 (which has an outer diameter of 0.60 mm) of the signal wire 20 is prepared. Similarly, seven AWG 20 annealed copper wires (each wire having approximately 0.53 sq) are twisted together such that the conductor 11 (which has an outer diameter of 0.96 mm) of the power supply wire 10 is prepared.

Subsequently, the outer circumferences of the conductors 11 and 21 are respectively coated with the insulators 12 and 22 using an extrusion machine. The insulators 12 and 22 are made of cross-linked PE foam, and both the power supply wire 10 coated with the insulator 12 and the signal wire 20 coated with the insulator 22 have an outer diameter of 1.4 mm.

Subsequently, the power supply wires 10 are disposed diagonally to each other, the signal wires 20 are disposed diagonally to each other, and the power supply wires 10 and the signal wires 20 are collectively twisted together. At this time, for example, a twist pitch is 40 mm, and a bundle of the power supply wires 10 and the signal wires 20 twisted together has an outer diameter of 3.3 mm.

Subsequently, the inner shielding layer 31 is formed on the power supply wires 10 and the signal wires 20 twisted together. The inner shielding layer 31 is a metal foil shield, and is made of an aluminum-deposited PET film or the like.

Thereafter, the outer shielding layer 32 is provided on the inner shielding layer 31. The outer shielding layer 32 is a braided shield, and is a braid in which tin-plated annealed copper wires or the like are braided together. The cable after the outer shielding layer 32 is formed has an outer diameter of 4.0 mm.

Subsequently, the sheath 40 is formed on the outer shielding layer 32. The sheath 40 is made of PVC or the like, and the cable after the sheath 40 is formed has a finished outer diameter of 4.9 mm.

The signal cable 1 is manufactured in this manner. As described above, for example, the twist pitch when the wires are collectively twisted together is 40 mm. The reason for this is as described below. FIG. 5 is a graph illustrating a correlation between the wire twist pitch and strain applied to the conductor (which is made of annealed copper). FIG. 5 illustrates strain when changing the twist pitch while manufacturing the signal cable 1 having the dimensions illustrated in FIG. 4.

As illustrated in FIG. 5, when the twist pitch is 25 mm, the strain of the conductors 11 and 21 is approximately 1.25%, and when the twist pitch is 30 mm, the strain of the conductors 11 and 21 is approximately 0.85%. When the twist pitch is 35 mm, the strain of the conductors 11 and 21 is approximately 0.65%, and when the twist pitch is 40 mm, the strain of the conductors 11 and 21 is approximately 0.5%. When the twist pitch is 45 mm, the strain of the conductors 11 and 21 is approximately 0.4%.

As such, the strain of the conductors 11 and 21 tends to be decreased to the extent that the twist pitch is increased. In the embodiment, when the conductors 11 and 21 are made of annealed copper, the strain of the conductors 11 and 21 is less than or equal to 0.5%. Therefore, the twist pitch may be greater than or equal to 40 mm when manufacturing the signal cable 1 having the dimensions illustrated in FIG. 4. In particular, the amount of strain of the conductors 11 and 21 cannot be observed from the outside, and thus it is not possible to twist the wires while paying attention to the amount of strain. In contrast, it is possible to limit the strain to 0.5% or less, and to easily manufacture the cable by twisting the wires together in order for the twist pitch to be greater than or equal to 40 mm while paying attention to the twist pitch based on the data illustrated in FIG. 5.

In the signal cable 1 having the dimensions illustrated in FIG. 4, when the conductors 11 and 21 are made of SnCC or an NN alloy, the twist pitch may be set to the values which will be described below. FIG. 6 is a graph illustrating a correlation between the wire twist pitch and strain applied to the conductor (which is made of SnCC or an NN alloy).

As illustrated in FIG. 6, when the twist pitch is 25 mm, the strain of the conductors 11 and 21 is approximately 1.25%, and when the twist pitch is 30 mm, the strain of the conductors 11 and 21 is approximately 0.85%. When the twist pitch is 35 mm, the strain of the conductors 11 and 21 is approximately 0.65%, and when the twist pitch is 40 mm, the strain of the conductors 11 and 21 is approximately 0.5%. When the twist pitch is 45 mm, the strain of the conductors 11 and 21 is approximately 0.4%. When the twist pitch is 50 mm, the strain of the conductors 11 and 21 is approximately 0.32%. When the twist pitch is 55 mm, the strain of the conductors 11 and 21 is approximately 0.30%.

In the embodiment, when the conductors 11 and 21 are made of SnCC or an NN alloy, the strain of the conductors 11 and 21 is less than or equal to 0.3%. Therefore, the twist pitch may be greater than or equal to 55 mm when manufacturing the signal cable 1 having the dimensions illustrated in FIG. 4. As a result, it is possible to easily manufacture the signal cable 1 in the aforementioned manner.

In the signal cable 1 according to the embodiment, the conductors 11 of the power supply wires 10 and the conductors 21 of the signal wires 20 are twisted together in such a way that the strain of the conductors 11 and 21 twisted together is present within the range of an elastic range. For this reason, the conductors 11 and 21 are not plastically deformed, and thus it is possible to relatively easily untwist the power supply wires 10 and the signal wires 20 in the untwisting step. As a result, it is possible to improve processing properties of terminals without spending a large amount of time in untwisting the wires.

The material of the conductor 11 of the power supply wire 10 and the conductor 21 of the signal wire 20 is not limited to the annealed copper wire illustrated in FIG. 4. Examples of the material of the conductors 11 and 21 include an alloy wire, a copper-coated steel wire, a silver-plated annealed copper wire, a tin-plated annealed copper wire, a tin-plated copper alloy wire, a tin-plated copper-coated steel wire, and the like. Even if the conductors 11 and 21 are made of these materials, it is possible to improve processing properties of terminals without spending a large amount of time in untwisting the wires insofar as the strain of the wires when untwisted is present within a range of the corresponding elastic region.

The conductors 11 and 21 are made of annealed copper, and are twisted together in such a way that the strain of the conductors 11 and 21 twisted together is less than or equal to 0.5%. For this reason, even if the twisting of the conductor 11 of the power supply wire 10 and the conductor 21 of the signal wire 20 is performed in a range of the elastic region, and the conductors 11 and 21 are made of annealed copper, it is possible to improve processing properties of terminals without spending a large amount of time in untwisting the wires.

The conductors 11 of the power supply wires 10 and the conductors 21 of the signal wires 20 are twisted together such that the twist pitch is greater than or equal to 40 mm. For this reason, in the signal cable 1 in which the conductors 11 and 21 are made of annealed copper, each of the power supply wires 10 has a conductor outer diameter of 0.96 mm, each of the signal wires 20 has a conductor outer diameter of 0.60 mm, each of the insulator-coated power supply wire 10 and the insulator-coated signal wire 20 has an outer diameter of 1.4 mm, it is possible to limit the strain of the conductors 11 and 21 twisted together to 0.5% or less by setting the twist pitch to be greater than or equal to 40 mm. Therefore, it is possible to limit the strain of the conductors 11 and 21 to 0.5% or less by twisting the power supply wires 10 and the signal wires 20 together in order for the twist pitch to be greater than or equal to 40 mm while paying attention to the twist pitch according to the conductor outer diameter of each of the power supply wire 10 and the signal wire 20, and the outer diameter of each of the insulator-coated power supply wire 10 and the insulator-coated signal wire 20. As a result, it is possible to easily manufacture the cable.

The insulator 12 of the power supply wire 10 and the insulator 22 of the signal wire 20 are made of low density polyethylene or polyethylene foam. The insulators 12 and 22 are made of a material having a low hardness, and thus it is possible to further improve processing properties of terminals without spending a large amount of time in untwisting the wires.

The present invention has been described with reference to the embodiment; however, the present invention is not limited to the embodiment, and modifications may be made to the embodiment insofar as the modifications do not depart from the purport of the present invention.

The signal cable 1 in the embodiment is not limited to the cable described with reference to FIG. 4, and various forms of modifications can be made thereto. For example, the conductors 11 and 21 may be annealed copper twisted wires, and the sheath 40 may not be made of PVC. Similarly, various forms of modifications can be made to the insulators 12 and 22 or the shielding layer 30.

The signal cable 1 in the embodiment can be used as one of a plurality of electrical wires of a wire harness. Since it is not necessary to spend a large amount of time in untwisting the signal cable 1, it is possible to reduce an amount of time required to manufacture the wire harness including the signal cable 1 as one of the plurality of electrical wires.

Characteristics of the signal cable and the wire harness in the embodiment of the present invention are briefly summarized below in [1] to [5].

[1] A signal cable (1) comprising:

a pair of power supply wires (10); and

a pair of signal wires (20),

wherein each of the pair of the power supply wires comprises:

a conductor (11); and

an insulator (12) with which the conductor of the power supply wire is coated,

wherein each of the pair of the signal wires (20) comprises:

a conductor (21); and

an insulator (22) with which the conductor of the signal wire is coated,

wherein the pair of the power supply wires and the pair of the signal wires are respectively disposed diagonally,

wherein the power supply wires and the signal wires are collectively twisted together, and

wherein the conductors of the power supply wires and the conductors of the signal wires are respectively twisted together in a state that strains of the conductors of the power supply wires and the conductors of the signal wires are within a range of an elastic region.

[2] The signal cable according to [1],

wherein the conductors of the power supply wires and the conductors of the signal wires are made of annealed copper, and

wherein the conductors of the power supply wires and the conductors of the signal wires are twisted together in a state that the strains of the conductors of the power supply wires and the conductors of the signal wires are less than or equal to 0.5%.

[3] The signal cable according to [2], wherein the conductors of the power supply wires and the conductors of the signal wires are twisted together so that each of twist pitches is greater than or equal to 40 mm.

[4] The signal cable according to any one of [1] to [3], the insulators of the power supply wires and the insulators of the signal wires are made of low density polyethylene or polyethylene foam.

[5] A wire harness comprising the signal cable according to any one of [1] to [4].

The present invention has been described in detail with reference to the specific embodiment, and it is apparent to persons skilled in the art that various forms of modifications or corrections can be made to the embodiment insofar as the modifications or the corrections do not depart from the spirit and the scope of the present invention.

This application is claimed based on Japanese Patent Application No. 2013-102841 filed on May 15, 2013, the content of which is incorporated herein for reference.

### INDUSTRIAL APPLICABILITY

According to the signal cable of the present invention, it is possible to improve processing properties of terminals. The present invention with the effect is applicable to the signal cable.

### REFERENCE SIGNS LIST

1: signal cable

10: power supply wire

11: conductor

12: insulator

20: signal wire

21: conductor

22: insulator

30: shielding layer

31: inner shielding layer

32: outer shielding layer

40: sheath

What is claimed is:

1. A signal cable comprising:
a pair of power supply wires; and
a pair of signal wires,
wherein each of the pair of the power supply wires comprises:
a conductor; and
an insulator with which the conductor of the power supply wire is coated,
wherein each of the pair of the signal wires comprises:
a conductor; and
an insulator with which the conductor of the signal wire is coated,
wherein the pair of the power supply wires and the pair of the signal wires are respectively disposed diagonally,
wherein the power supply wires and the signal wires are collectively twisted together, and
wherein the conductors of the power supply wires and the conductors of the signal wires are respectively twisted together in a state that strains of the conductors of the power supply wires and the conductors of the signal wires are within a range of an elastic region.

2. The signal cable according to claim 1,
wherein the conductors of the power supply wires and the conductors of the signal wires are made of annealed copper, and
wherein the conductors of the power supply wires and the conductors of the signal wires are twisted together in a state that the strains of the conductors of the power supply wires and the conductors of the signal wires are less than or equal to 0.5%.

3. The signal cable according to claim 2,
wherein the conductors of the power supply wires and the conductors of the signal wires are twisted together so that each of twist pitches is greater than or equal to 40 mm.

4. The signal cable according to any one of claim 1,
wherein the insulators of the power supply wires and the insulators of the signal wires are made of low density polyethylene or polyethylene foam.

5. A wire harness comprising the signal cable according to claim 1.

6. A wire harness comprising the signal cable according to claim 2.

7. A wire harness comprising the signal cable according to claim 3.

8. A wire harness comprising the signal cable according to claim 4.
